(19) United States
(12) Patent Application Publication
(10) Pub. No.: US 2024/0185230 A1
(43) Pub. Date: Jun. 6, 2024

(54) MACHINE LEARNING INTELLIGENT GATEWAY SELECTION FOR TRANSACTION ROUTING

(71) Applicant: Microsoft Technology Licensing, LLC, Redmond, WA (US)

(72) Inventors: Xianyun MAO, Mountain View, CA (US); Rachit KUMAR, Newark, CA (US); Jiaqi XU, Foster City, CA (US); Vikas Ramakrishne GOWDA, Bangalore (IN); Piyush KESHRI, Sunnyvale, CA (US); Shuosheng Huang, Newark, CA (US); Tian Hong Tim Tan, New York City, NY (US); Divyakumar Kamal Menghani, San Francisco, CA (US); Dmitry Berdnikov, Miami, FL (US)

(21) Appl. No.: 18/048,413

(22) Filed: Oct. 20, 2022

(51) Int. Cl. G06Q 20/38; G06N 20/00

(52) U.S. Cl. CPC G06Q 20/38; G06N 20/00

(57) ABSTRACT

Technologies for selecting a gateway for processing a request from a user system are described. Embodiments receive the request from the user system, where the request includes user profile data including a transaction request and associated user data. Embodiments identify gateways that are available to process the request. Embodiments sample historical gateway data for the available gateways using a sampling function optimized for at least two different optimization parameters. Embodiments select, by a first trained machine learning model trained based on the sampled historical gateway data, a gateway from the available gateways. Embodiments communicate the request to the selected gateway. Embodiments receive, from the selected gateway, a response that indicates a success or failure of the request.

### TECHNICAL FIELD

The present disclosure generally relates to transaction routing, and more specifically, relates to machine learning-based intelligent gateway selection for transaction routing.

### BACKGROUND

Online platforms, such as digital marketplaces, have gateways through which various transactions are processed. A gateway is a hardware device and/or software-based application that transfers transaction information, such as payment information, from a user's device to a transaction processing system, such as a payment processing system of a merchant's financial institution. For example, when a user initiates a purchase of merchandise through an online system, a gateway can determine whether to approve or complete the requested purchase transaction. Different gateways have different reliability characteristics for determining the success and failure of processing various transactions. As online platforms operate with an increasingly global user base, more and more gateways are becoming available to process user requests and transactions.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system 100A that includes an intelligent gateway manager in accordance with some embodiments of the present disclosure.

FIG. 1B illustrates an example computing system 100B that includes processing a transaction request using an intelligent gateway manager in accordance with some embodiments of the present disclosure.

FIG. 2 is a flow diagram of an example method 200 of training and deploying an intelligent gateway manager in accordance with some embodiments of the present disclosure.

FIG. 3 is a flow diagram of an example method 300 of training machine learning models to predict a gateway device in accordance with some embodiments of the present disclosure.

FIG. 4 is a flow diagram of an example method 400 of intelligent gateway selection using machine learning in accordance with some embodiments of the present disclosure.

FIG. 5 is an example chart 500 comparing performance of a typical rule-based approach and intelligent gateway selection using machine learning in accordance with some embodiments of the present disclosure.

FIG. 6 is a block diagram of an example computer system in which embodiments of the present disclosure can operate.

### DETAILED DESCRIPTION

Transaction processing has widely variable success rates due to geography, payment processing regulations, and customer data. For example, payment gateways operate between e-commerce applications and financial institutions for routing transactions. Various payment gateways are configured differently and thus have different rejection parameters that cause particular transactions to fail. Typical rules-based systems are not scalable or configurable to accommodate changes in performance of payment gateways. In existing approaches, gateways are selected by evaluating a set of pre-determined or static rules that are designed to result in transaction success. For instance, using a set of rules to determine which time of day corresponds to a gateway for selection (e.g., select gateway 1 between 12 AM-11:59 PM and gateway 2 between 12 PM -11:59 PM). However, because existing approaches use pre-determined or static rules, existing approaches are only able to optimize for a single outcome based on the design of the rules (e.g., success rate). As a result, existing approaches are unable to scale to multiple outcomes such as transaction cost, potential cost of fraudulent transaction, and opportunity cost of selecting a particular gateway over another gateway.

Aspects of the present disclosure address the above and other deficiencies by intelligently selecting a payment gateway using a machine learning model to predict a gateway device based on historical transactions processed by the gateway devices. By using the historical transactions, the machine learning model can select a gateway device that has a greater likelihood of a successful transaction. The machine learning model provides a flexible and scalable solution that adapts for variations in performance of the gateway devices.

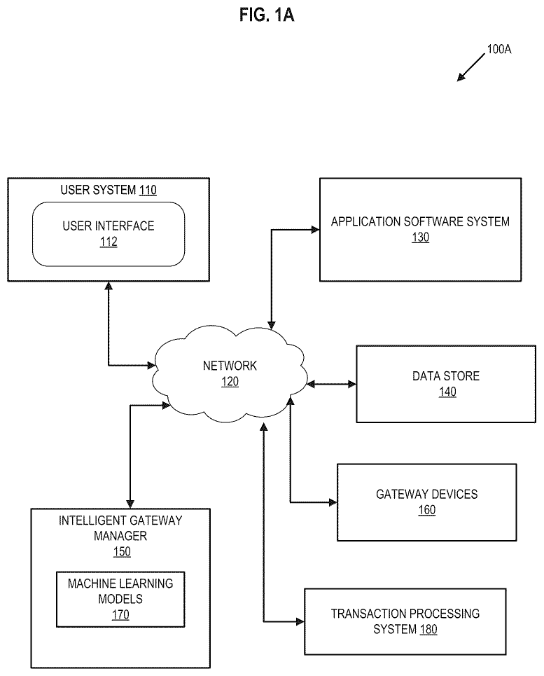

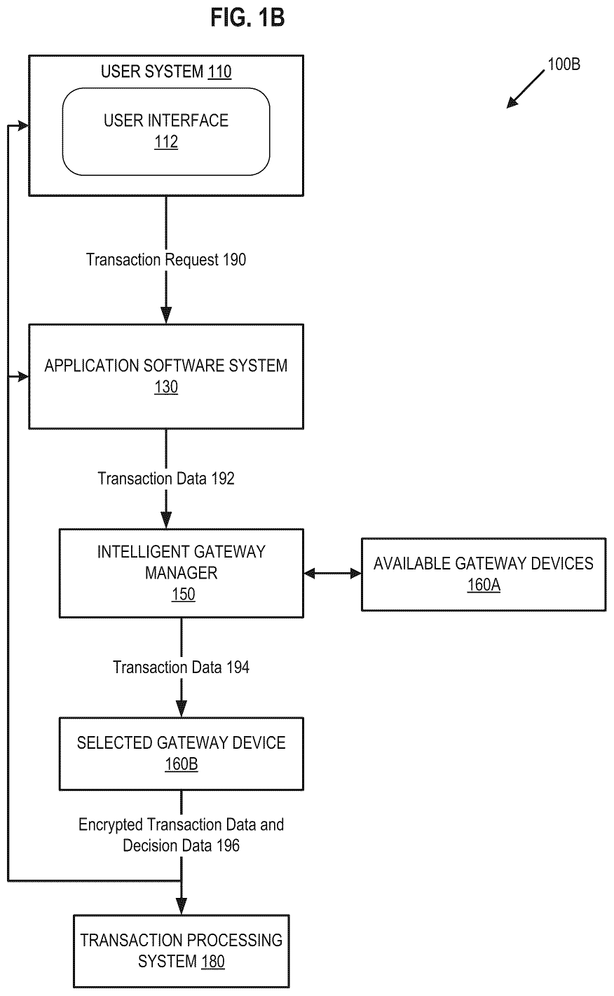

FIG. 1A illustrates an example computing system 100A that includes an intelligent gateway manager in accordance with some embodiments of the present disclosure.

In the embodiment of FIG. 1A, computing system 100A includes a user system 110, a network 120, an application software system 130, a data store 140, an intelligent gateway manager 150, and gateway devices 160.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to input search queries and view or otherwise perceive output that includes data produced by application software system 130. For example, user interface 112 can include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein can include application programming interfaces (APIs).

Data store 140 is a memory storage. Data store 140 stores machine learning model data, transaction request data, user profile data, and historical transaction data. Data store 140 can reside on at least one persistent and/or volatile storage device that can reside within the same local network as at least one other device of computing system 100A and/or in a network that is remote relative to at least one other device of computing system 100A. Thus, although depicted as being included in computing system 100A, portions of data store 140 can be part of computing system 100A or accessed by computing system 100A over a network, such as network 120.

Application software system 130 is any type of application software system that includes or utilizes functionality provided by intelligent gateway manager 150. Examples of application software system 130 include but are not limited to connections network software, such as social media platforms, and systems that are or are not based on connections network software, such as general-purpose search engines, job search software, recruiter search software, sales assistance software, advertising software, learning and education software, or any combination of any of the foregoing.

While not specifically shown, it should be understood that any of user system 110, application software system 130, data store 140, intelligent gateway manager 150, and gateway devices 160 includes an interface embodied as computer programming code stored in computer memory that when executed causes a computing device to enable bidirectional communication with any other of user system 110, application software system 130, data store 140, intelligent gateway manager 150, and gateway devices 160 using a communicative coupling mechanism. Examples of communicative coupling mechanisms include network interfaces, inter-process communication (IPC) interfaces and application program interfaces (APIs).

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

Each of user system 110, application software system 130, data store 140, intelligent gateway manager 150, and gateway devices 160 is implemented using at least one computing device that is communicatively coupled to electronic communications network 120. Any of user system 110, application software system 130, data store 140, intelligent gateway manager 150, and gateway devices 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, intelligent gateway manager 150, and/or gateway devices 160. User system 110 is configured to communicate bidirectionally with any of application software system 130, data store 140, intelligent gateway manager 150, and/or gateway devices 160 over network 120.

The features and functionality of user system 110, application software system 130, data store 140, intelligent gateway manager 150, and gateway devices 160 are implemented using computer software, hardware, or software and hardware, and can include combinations of automated functionality, data structures, and digital data, which are represented schematically in the figures. User system 110, application software system 130, data store 140, intelligent gateway manager 150, and gateway devices 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner

Network 120 can be implemented on any medium or mechanism that provides for the exchange of data, signals, and/or instructions between the various components of computing system 100A. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

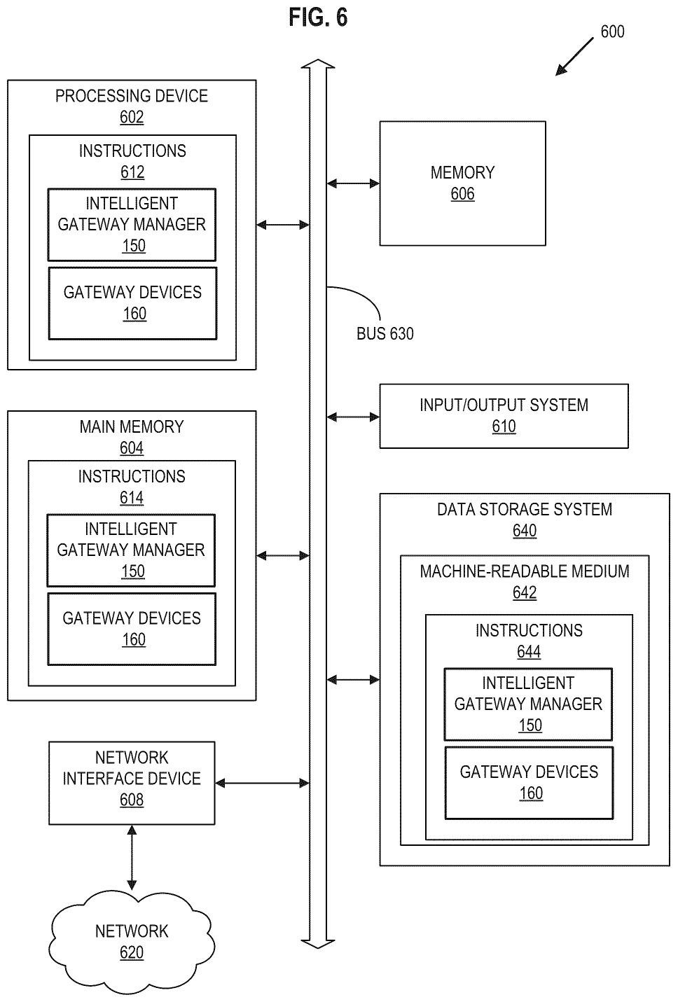

The computing system 110 includes an intelligent gateway manager 150 that can train machine learning models to select a gateway device of the gateway devices 160 for processing a transaction. In some embodiments, the application software system 130 includes at least a portion of the intelligent gateway manager 150. As shown in FIG. 6, the intelligent gateway manager 150 can be implemented as instructions stored in a memory, and a processing device 602 can be configured to execute the instructions stored in the memory to perform the operations described herein.

The intelligent gateway manager 150 can include machine learning models 170 that can be trained to select a gateway device using a multi-arm bandit problem. The disclosed technologies can be described with reference to an example use case of selecting a gateway device using a predicted success of processing transactions using the gateway device; for example, an e-commerce application, such as a professional social network application with an online marketplace. The disclosed technologies are not limited to e-commerce applications but can be used to perform gateway selection more generally. The disclosed technologies can be used by many different types of network-based applications in which routing processes through certain paths of devices are configurable, for example, selecting a routing path for a request to the social network application such as network traffic routing, a help desk ticketing routing, or other configurable routes.

The gateway devices 160 can include multiple devices or software applications that receive transaction information such as customer profile data and transaction payment data (e.g., payment card details, authentication, etc.). The gateway devices 160 route the payment data and a portion of the customer profile data to a financial institution for transaction settlement and approval. Different configurations, locations, and payment data impact the success rate of various gateway devices. For example, transaction requests from certain locations, or having certain payment data (e.g., card number, card issuer) may be more likely to result in a failure or rejection than others. As a result, some gateway devices will more reliably have success for processing the transaction while other gateway devices will have a lower reliability.

The machine learning models 170 can include a number of machine learning models that are trained to predict a gateway device from gateway devices 160 that is likely to successfully process the transaction received from the user system 110. For example, the machine learning models 170 can distribute multiple transactions across different gateway devices that have different success rates for processing transactions. The machine learning models 170 can be retrained at time intervals to adapt to changes in success rates for one or more of the gateway devices. By applying the trained machine learning models 170 to the transaction request, the number of transactions that are routed to unreliable gateway devices will be reduced. In some embodiments, the machine learning models 170 can include multiple models, such as a model previously trained and a retrained model after the time interval. A change in success rate can be monitored between the models to determine if the retraining improved the success rate. Further details with regards to the operations of the intelligent gateway manager 150 and gateway devices 160 are described below.

FIG. 1B illustrates an example computing system 100B that includes processing a transaction request using an intelligent gateway manager in accordance with some embodiments of the present disclosure. For example, the user system 110 receives a request via the user interface 112 and the request is processed by a gateway that is selected using the intelligent gateway manager 150.

In some embodiments, the user system 110 includes a front-end portion of application software system 130, such as the user interface 112. The user system 110 receives a transaction request that indicates a transaction identifier and other payment data. The user system 110 provides the transaction request 190 to the application software system 130.

The application software system 130 identifies a set of parameters associated with the transaction request 190. In some embodiments, the set of parameters includes a currency, a method of payment (e.g., payment card data), or other information which is used to process the transaction request 190. The application software system 130 can include a portion of the intelligent gateway manager 150 to identify available gateway devices 160A (as a subset of gateway devices 160). The intelligent gateway manager uses a machine learning prediction to select one of the available gateway devices 160A for processing the transaction request 190 with the transaction data 192.

The intelligent gateway manager 150 provides the transaction data 194 to the selected gateway device 160B. The transaction data 194 includes the transaction request 190 and the set of parameters that are included in the transaction data 192. The selected gateway device 160B processes the transaction request to complete payment of the value associated with the transaction request. In some embodiments, the selected gateway device 160B determines if processing the transaction request resulted in a successful or unsuccessful transaction completion identifier.

After completion of processing the transaction request, the selected gateway device 160B encrypts the transaction data and the completion identifier. The selected gateway device 160B provides the encrypted transaction data and the completion identifier that indicates the success or failure of the transaction to a transaction processing system 180 and to application software system 130. In some embodiments, the transaction processing system 180 generates a record of the transaction including the transaction identifier, gateway identifier, payment card, and other payment data. In some embodiments, application software system 130 receives a set of recently processed transactions including the encrypted transaction data and decision data 196 from the selected gateway device 160B. During subsequent processing of an additional transaction request, the application software system 130 augments the transaction data 192 to include the set of recently processed transactions. The set of recently processed transactions including the encrypted transaction data and decision data 196 enables intelligent gateway manager 150 to provide adaptable decision data in response to detecting changes to performance of the gateway device 160B. For example, gateway device 160B may suffer an outage and go offline for an extended period. The outage is reflected in transactions and encrypted transaction data and decision data 196 and used by the application software system 130 or the intelligent gateway manager 150 for subsequent selections after the transaction data 192 is augmented by the application software system 130 as described above.

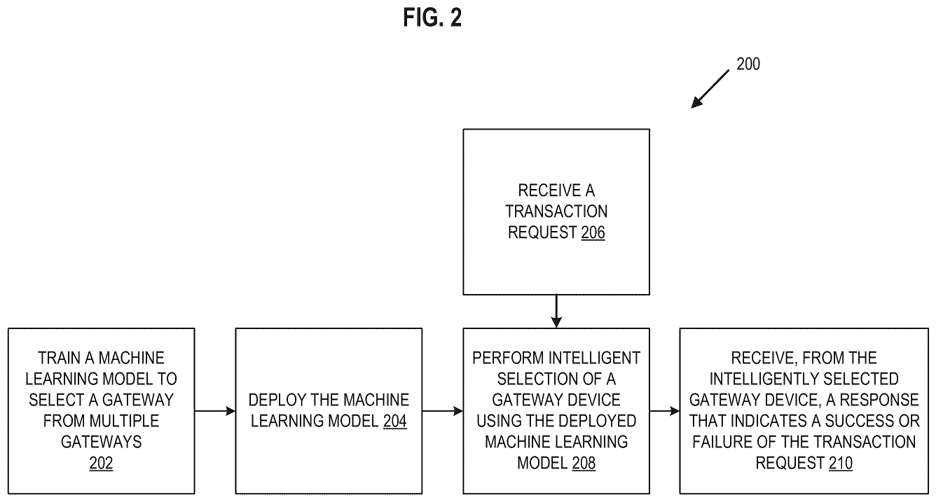

FIG. 2 is a flow diagram of an example method 200 of training and deploying an intelligent gateway manager in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the intelligent gateway manager 150 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 202, the intelligent gateway manager trains a machine learning model to select a gateway from multiple gateways. In some embodiments, the machine learning model is trained using supervised learning on a set of training payment gateways, a set of training input variables including payment data. In an example, the currency, country, payment card, and time of transaction are used along with other configurable options to include additional payment or transaction data. The machine learning model learns to generate a selection of a gateway from the set of training payment gateways by predicting a probability of success of each gateway. The set of training input variables is based on historical transactions and a transaction completion identifier associated with the success or failure of processing for each historical transaction. The transaction completion identifier is used as the response variable that provides feedback to the machine learning model. The payment data included in the set of training input variables includes features such as card type (credit card or debit), card issuer (bank name), card network (VISA, MASTERCARD, AMERICAN EXPRESS, etc.), payment amount, currency, billing country, hour of the day at which the transaction is processed, bank identification number (e.g., first 4 to 6 digit of a card number) and other metadata associated with the card type, such as prepaid indicator and virtual card indicator. A supervised learning algorithm such as logistic regression, decision tree or a neural network can be used for the training The supervised learning algorithm inputs the features and the transaction completion identifier (e.g., feedback to the model) and trains the machine learning model to generate predictions of success or failure for test transaction data unseen by the model during training.

In some embodiments, the machine learning model is trained by mapping input features and the transaction completion identifier to real numbers. The machine learning model defines a cost function to measure a cost of predicting the best gateway being a selected gateway (e.g., gateway A or gateway B) in comparison to the ground truth gateway. In some embodiments, the machine learning model determines that the cost for a correct prediction is less than a wrong prediction. A random sample of the training input variables is selected and a cross-validation process is performed. The cross-validation process splits the sampled training input variables into a number of k subsets. Each of the k−1 subsets are used to minimize the cost function and generate a real number mapping that selects the gateway that minimizes cost function as the predicted best gateway. The k−1 mappings are then averaged to generate a new aggregated mapping. The last subset k is used to compute a performance of the machine learning model that uses the cost computed with the new aggregated mapping. In some embodiments, any number of different cost functions are used for cross validation. A best cost function is selected after computing the performance of the machine learning model. An example of cost functions includes using the mean difference between the predict value and the true value, the mean square of the differences, or a SoftMax function.

At operation 204, the intelligent gateway manager deploys the machine learning model. In some embodiments, the intelligent gateway manager implements the trained machine learning model for inference operations. For example, the intelligent gateway manager compiles code for the machine learning model and prepares a container for execution by the intelligent gateway manager In some embodiments, the intelligent gateway manager configures the machine learning model to receive transaction requests and identify available gateways for selection.

At operation 206, the intelligent gateway manager receives a transaction request. In some embodiments, a transaction having an associated gateway is received by the intelligent gateway manager. For example, the transaction includes a transaction identifier, a gateway device identifier, and other payment data.

At operation 208, the intelligent gateway manager performs intelligent gateway selection by the machine learning model trained at operation 202. In some embodiments, the trained machine learning model selects the gateway from a set of multiple gateways. The machine learning model predicts a probability of a successful transaction for each gateway and selects the gateway that has the greatest probability of the transaction successfully being completed. Alternatively, 208 can take additional input such as real time data (recent transaction and completion flag 207). In one embodiment, operation 208 uses the real time data to reweight the probability of a successful transaction for each gateway 202. A gateway with higher success rate in the recent time receives more weight in the reweighting process. In another embodiment, 208 employs a meta-model of many models from 202 that each is trained on different scenarios. The recent transaction and completion flag 207 is used to reweight the individual models within the meta-model.

At operation 210, the intelligent gateway manager receives an indication from the selected gateway device, for example a response that indicates a success or failure of the request. In some embodiments, the gateway device generates a transaction completion identifier that represents the status of the transaction request. As described above, the transaction completion identifier is included in the recent transaction and completion flag 207. During processing of subsequent transaction requests, the intelligent gateway manager receives the recent transaction and completion flag 207 to augment the transaction request 206 to include recent transaction and completion flag 207. The recent transaction and completion flag 207 enables intelligent gateway manager to provide adaptable decision data that responds to the recent transactions and the transaction requests. In some embodiments, the transaction completion identifier is included in the recent transaction and completion flag 207 is used to update the machine learning model trained at operation 202.

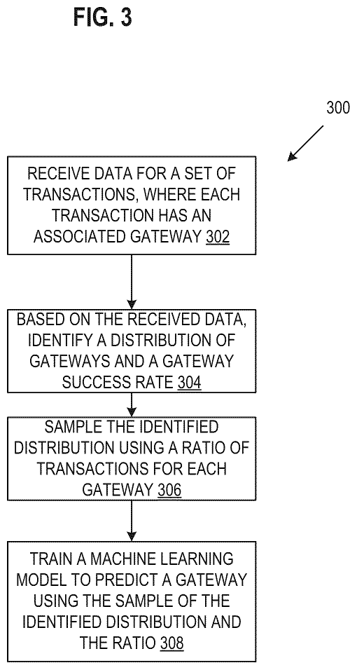

FIG. 3 is a flow diagram of an example method 300 of training machine learning models to predict a gateway device in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the intelligent gateway manager 150 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 302, the intelligent gateway manager 150 receives a set of transactions with each transaction having an associated gateway. For example, the set of transactions includes a set of historical transaction data that have been previously processed by one or more gateway devices. The set of historical transaction data includes a transaction identifier, a gateway device identifier, payment data, and a transaction completion identifier. The transaction completion identifier indicates a success or failure of the transaction associated with the transaction identifier.

At operation 304, the intelligent gateway manager 150 identifies a distribution of gateways and a gateway success rate. The distribution is a ratio of a number of transactions that are processed by the first gateway in comparison to a number of transactions processed by other gateways. In some embodiments, a number of transactions is processed by each of the gateway devices over a time interval based on how many transactions are assigned to each gateway device. For instance, the distribution represents a ratio of transactions that are routed to each gateway. In an example, if 100,000 transactions are distributed between two gateway devices such as by routing 40,000 transactions to gateway A and 60,000 transactions to gateway B, the distribution is gateway A: 0.4, gateway B: 0.6. The gateway success rate is a corresponding success rate for each of the gateway devices represented in the distribution. In an example, gateway A has a success rate of 75% and gateway B has a success rate of 60%. The success rates given in this example are a measured performance (e.g., transaction completion identifier) of each gateway. In other examples, the success rates are determined by comparing a total number of transactions processed by each gateway and the number of successfully completed transactions processed by each gateway.

At operation 306, the intelligent gateway manager 150 samples the transactions using distribution of gateways using a ratio of transactions for each gateway. After identifying the distribution, the intelligent gateway manager removes a bias in the transaction data by using the distribution to perform the sampling such that gateway B is not favored during training despite having processed more overall transactions. By using the distribution instead of a raw count of processed transactions, a bias towards a gateway that receives more transactions but has a lower success rate is removed.

For example, the sample of each gateway is based on the success rate. Continuing with the previous example, the intelligent gateway manager 150 samples 50,000 transactions using Inverse Probability Weighting Sampling to result in a set including 37,500 successful transactions from Gateway A (75% of 50,000), 30,000 successful transactions from Gateway B (60% of 50,000), and 32,500 failed transactions. Inverse Probability Weighting Sampling uses the probability of a successful outcome (each success rate) to sample the gateways. By using the probability of successful outcomes of past transactions, Inverse Probability Weighting Sampling increases a likelihood of training to select a successful outcome.

At operation 308, the intelligent gateway manager 150 trains a machine learning model to predict a gateway using the distribution and the ratio. In some embodiments, the machine learning model is trained on a number k of payment gateways, a set of input variables [symbol] including currency, country, payment card, time of transaction. and other payment data is input to the machine learning model. The model generates a routing action a that selects a gateway from the k gateways such that the routing action is represented as an element of {1, . . . K} that indicates an index or identifier of the selected gateway. Using the set of input variables [symbol] , the machine learning model predicts a probability of success of each gateway. The success probabilities are learned by ingesting the historical data into the machine learning model. The success probabilities can be represented by θ.

In some embodiments, the machine learning model is an aggregate model that includes multiple machine learning models. For example, each individual machine learning model is trained on a specific gateway performance scenario, such as a success rate for gateway A of 50% and a success rate for gateway B of 90%. By training a machine learning model for each gateway performance scenario, multiple machine learning models are generated and can be selected based on the gateway performance of the gateway measured at operation 306. Using a model that includes multiple models, recently processed transaction data including a transaction completion identifier 207 are used to adjust the relative weights for an individual model in the aggregate model.

In some embodiments, the machine learning model is a reinforcement learning model. For example, a Thompson sampling model is trained using successful transactions as reward for a correct prediction with each gateway providing reward using an unknown probability (to the machine learning model) that represents the success rate for each gateway. For each transaction request that is received, a gateway is selected based on a sampling algorithm and the transaction completion identifier is recorded. The sampling algorithm is applied to every gateway, with a random draw from a beta distribution having a shape determined by a number of success and failures in response to selecting a particular gateway in a historical time interval. For each decision, the gateway with the highest beta value is selected. The transaction completion identifier of the transaction will be provided to the algorithm as feedback to update the beta distribution to reflect the most recent success and failure of processed transactions.

The machine learning model selects the routing action a* that maximizes an expected reward function that can be represented by E(r|θ*, a*, x). Using a supervised training process, a set of parameters {A′, X′, R′} represent a collection of sampled (a, x, r) with a representing the routing action, x representing the set of input variables and r representing the success or failure of processing the transaction (e.g., the reward). With a sufficiently large sample, the sampling performed at operation 306 is more objective and not prone to a sample that skews in a particular short-term direction (e.g., epsilon greedy sample).

In some embodiments, the intelligent gateway manager 150 monitors a number of failures and compares the number of failures with a threshold number to determine if retraining the machine learning model should be performed. For example, 100 total failures, 50 failures within an hour, or an increase of the average failure rate above 50% within a defined time interval. In examples where the intelligent gateway manager 150 determines that retraining should be performed, the retraining occurs using updated historical gateway data including the sampled historical gateway data and additional historical gateway data.

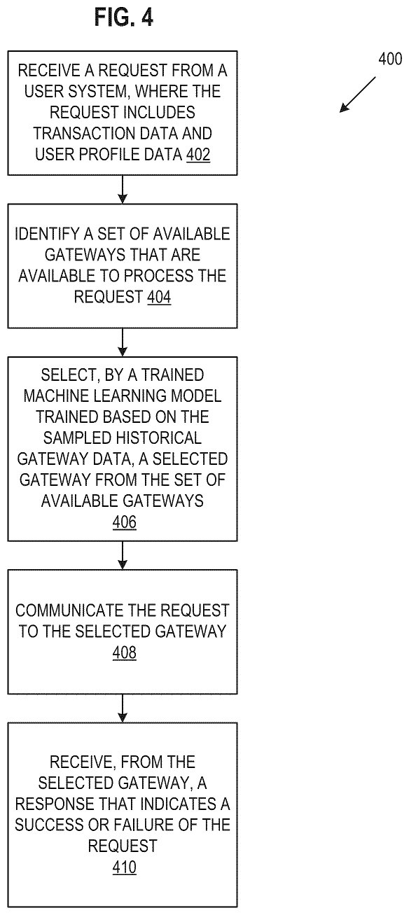

FIG. 4 is a flow diagram of an example method 400 for intelligent gateway selection using machine learning in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the intelligent gateway manager 150 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 402, the intelligent gateway manager 150 receives a request from a user system 110, the request including user profile data including a transaction request and associated user data. For example, the user system receives interactions from a user via the user interface 112 that indicates a transaction is being requested. For example, the interaction can include selecting a submit button, a complete transaction button, or another portion of the user interface that initiates processing of a transaction. The user profile data can include previous transactions associated with a user, a risk metric associated with a user profile that represents a likelihood of a fraudulent or fake transaction request, or other user profile details.

At operation 404, the intelligent gateway manager 150 identifies multiple gateways that are available to process the request. After receipt of the request to process the transaction, the intelligent gateway manager 150 identifies active (e.g., online or connected) gateway devices. In some embodiments, the intelligent gateway manager 150 polls active gateways or maintains a list of gateways which have an established connection.

At operation 406, the intelligent gateway manager 150 selects, by a trained machine learning model trained based on the sampled historical gateway data, the gateway from the gateways. The machine learning model predicts a probability of a successful transaction for each gateway and selects the gateway that has the greatest probability of the transaction successfully being completed. is described below. In some embodiments, the machine learning model is trained the intelligent gateway manager 150 using a sampling of historical gateway data for multiple gateways. For example, the historical gateway data includes a set of transaction records that represent historical transactions that have been processed. The set of transaction records includes multiple records each including a transaction identifier, a gateway device identifier, payment data, and user profile data.

At operation 408, the intelligent gateway manager 150 communicates the request to the gateway. In some embodiments, the intelligent gateway manager 150 communicates the transaction, the payment data, and a portion of the user profile data to the selected gateway device for processing the transaction.

At operation 410, the intelligent gateway manager 150 receives, from the selected gateway device, a response that indicates a success or failure of the request. In some embodiments, the gateway device determines a success or a failure of processing the transaction request. The gateway device generates a transaction completion identifier such as a logical value, a “pass” or “fail” or another value that represents the status of the transaction. The intelligent gateway receives the transaction completion identifier from the selected gateway device and inserts the transaction data into the set of historical transaction data for a subsequent retraining of the machine learning model.

In some embodiments, the intelligent gateway manager 150 performs retraining of the machine learning model using updated historical transaction data. The retraining can be similar to the training operations described regarding at least FIG. 3. After retraining, the intelligent gateway manager 150 is configured to monitor performance between the trained machine learning model and the retrained machine learning model to determine if the retrained model has improved performance. If the performance (e.g., precision, recall, etc.) of the retrained machine learning model is greater than the performance of the machine learning model, the retrained machine learning model is selected for use. If the performance (e.g., precision, recall, etc.) of the retrained machine learning model is inferior to the performance of the machine learning model, the retrained machine learning model is rejected.

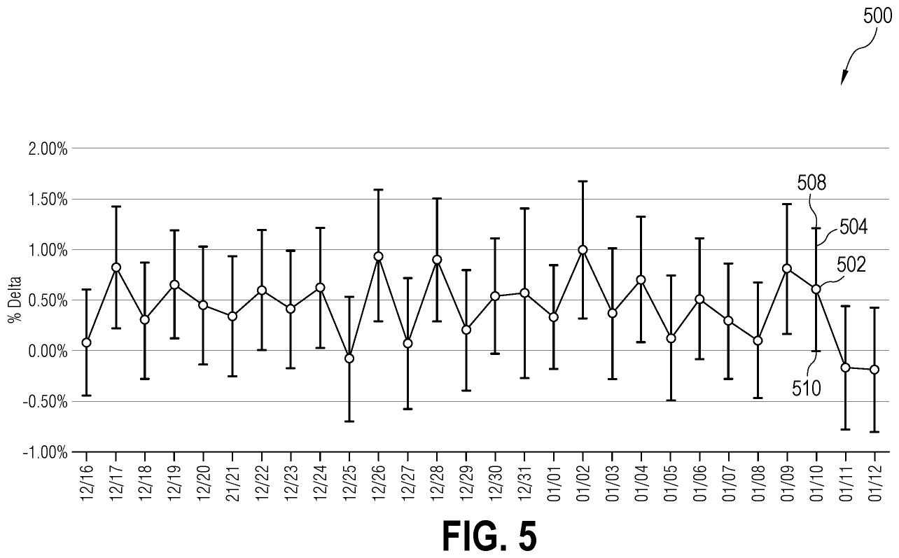

FIG. 5 is a chart of performance comparison between a typical rules-based approach and intelligent gateway selection using machine learning in accordance with some embodiments of the present disclosure. As illustrated by FIG. 5, a difference value 502 represents the difference between a success rate of a typical rules-based approach and the intelligent gateway selection. For instance, positive values of the difference value 502 (e.g., above 0.00%) represent an improvement in success rate using the intelligent gateway selection. A confidence interval 504 represents a range within which the value of the difference occurs. As illustrated In FIG. 5, the difference value 502 is computed between a success rate of processing transactions using intelligent gateway selection and a success rate of a rules-based approach. The confidence interval 504 represents a maximum value 508 and a minimum value 510 that define the range difference between performance of the models. As illustrated by FIG. 5, the maximum performance difference of confidence interval 504 is 1.25% as represented by the maximum value 508. Additionally, the minimum performance difference of confidence interval 504 is 0.00% as represented by the minimum value 510.

While FIG. 5 is depicted as a comparison between a rules approach and the intelligent gateway selection disclosed herein, the comparison can also be used between different machine learning models such as a previously trained model and a retrained model to determine if the retraining represents an improvement over the previously trained model. In this manner, models could be retrained on different sets of input variables, identify transient performance issues with a particular gateway, and evaluated against other models to select a model that has the best performance For example, the intelligent gateway manager 150 compares a threshold performance difference to a difference between a first performance metric of the previously trained model and a second performance metric of the retrained model. In some cases, the intelligent gateway manager determines that the difference does not satisfy the threshold performance difference and selects the previously trained (e.g., a machine learning model) to perform intelligent gateway selection. In other cases, the intelligent gateway manager determines that the difference satisfy the threshold performance difference and selects the previously trained (e.g., a machine learning model) to perform intelligent gateway selection.

FIG. 6 illustrates an example machine of a computer system 600 within which a set of instructions, for causing the machine to perform any one or more of the methodologies discussed herein, can be executed. In some embodiments, the computer system 600 can correspond to a component of a networked computer system (e.g., the computer system 100A of FIG. 1A) that includes, is coupled to, or utilizes a machine to execute an operating system to perform operations corresponding to the intelligent gateway manager 150 of FIG. 1A. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a memory 606 (e.g., flash memory, static random access memory (SRAM), etc.), an input/output system 610, and a data storage system 640, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 612 for performing the operations and steps discussed herein.

The computer system 600 can further include a network interface device 608 to communicate over the network 620. Network interface device 608 can provide a two-way data communication coupling to a network. For example, network interface device 608 can be an integrated-services digital network (ISDN) card, cable modem, satellite modem, or a modem to provide a data communication connection to a corresponding type of telephone line. As another example, network interface device 608 can be a local area network (LAN) card to provide a data communication connection to a compatible LAN. Wireless links can also be implemented. In any such implementation network interface device 608 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 600.

Computer system 600 can send messages and receive data, including program code, through the network(s) and network interface device 608. In the Internet example, a server can transmit a requested code for an application program through the Internet and network interface device 608. The received code can be executed by processing device 602 as it is received, and/or stored in data storage system 640, or other non-volatile storage for later execution.

The input/output system 610 can include an output device, such as a display, for example a liquid crystal display (LCD) or a touchscreen display, for displaying information to a computer user, or a speaker, a haptic device, or another form of output device. The input/output system 610 can include an input device, for example, alphanumeric keys and other keys configured for communicating information and command selections to processing device 602. An input device can, alternatively or in addition, include a cursor control, such as a mouse, a trackball, or cursor direction keys for communicating direction information and command selections to processing device 602 and for controlling cursor movement on a display. An input device can, alternatively or in addition, include a microphone, a sensor, or an array of sensors, for communicating sensed information to processing device 602. Sensed information can include voice commands, audio signals, geographic location information, and/or digital imagery, for example.

The data storage system 640 can include a machine-readable storage medium 642 (also known as a computer-readable medium) on which is stored one or more sets of instructions 644 or software embodying any one or more of the methodologies or functions described herein. The instructions 644 can also reside, completely or at least partially, within the main memory 604 and/or within the processing device 602 during execution thereof by the computer system 600, the main memory 604 and the processing device 602 also constituting machine-readable storage media.

In one embodiment, the instructions 626 include instructions to implement functionality corresponding to an intelligent gateway manager (e.g., the intelligent gateway manager 150 of FIG. 1A). While the machine-readable storage medium 642 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100B, can carry out the computer-implemented methods 200 and 300 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In an example 1, a method includes selecting a gateway for processing payment transactions in response to a request from a user system, the method comprising receiving the request from the user system, wherein the request includes user profile data and transaction data including payment data; identifying a plurality of gateways that are available to process the request; selecting, by a machine learning model trained based on a set of sampled historical gateway data, the selected gateway from the plurality of available gateways; communicating the request to the selected gateway; and receiving, from the selected gateway, a response that indicates a success or failure of the request.

An example 2 includes the subject matter of example 1, and further includes training the machine learning model using the set of sampled historical gateway data of each gateway of the available gateways to predict a likely gateway that can successfully process the request, wherein the training comprises sampling historical gateway data for the plurality of available gateways using a sampling function optimized for at least two different optimization parameters. An example 3 includes the subject matter of examples 1 or 2 and further includes identifying a threshold number of failed transactions; and in response to identifying the threshold number of failed transactions, generating an updated machine learning model by retraining the machine learning model using updated historical gateway data. An example 4 includes the subject matter of any of examples 1-3 and further includes measuring a difference between a first performance metric of the machine learning model and a second performance metric of the updated machine learning model. An example 5 includes the subject matter of any of examples 1-4 and further includes comparing the difference between the first performance metric and the second performance metric to a threshold performance difference; in response to determining that the difference does not satisfy the threshold performance difference, selecting the machine learning model to perform intelligent gateway selection; or in response to determining that the difference satisfies the threshold performance difference, selecting the updated machine learning model to perform intelligent gateway selection. An example 6 includes the subject matter of any of examples 1-5 and wherein the historical gateway data includes a plurality of records, each record including a transaction identifier, a gateway device identifier, payment data, and user profile data. An example 7 includes the subject matter of any of examples 1-6 and wherein the user profile data includes previous transactions associated with the user profile data, and a risk metric of a failed transaction associated with the user profile data.

In an example 8, a non-transitory computer-readable storage medium comprising instructions that, when executed by a processing device, cause the processing device to: receive a request from a user system, wherein the request includes user profile data including a transaction request and associated user data; identify a plurality of gateways that are available to process the request; select, by a machine learning model trained based on a set of sampled historical gateway data, a selected gateway from the plurality of available gateways; communicate the request to the selected gateway; and receive, from the selected gateway, a response that indicates a success or failure of the request.

An example 9 includes the subject matter of example 8, and further includes the processing device caused to: train the machine learning model using the historical gateway data of each gateway of the plurality of available gateways to predict a likely gateway that can successfully process the request, wherein to train the machine learning model comprises causing the processing device to sample historical gateway data for the plurality of available gateways using a sampling function optimized for at least two different optimization parameters. An example 10 that includes the subject matter of example 8 or 9, and further includes the processing device caused to: identify a threshold number of failed transactions; and in response to identifying the threshold number of failed transactions, generate an updated machine learning model by retraining the machine learning model using updated historical gateway data. An example 11 that includes the subject matter of any of examples 8-10, and further includes the processing device caused to measure a difference between a first performance metric of the machine learning model and a second performance metric of the updated machine learning model. An example 12 that includes the subject matter of any of examples 8-11, and further includes the processing device caused to: compare the difference between the first performance metric and the second performance metric to a threshold performance difference; in response to determining that the difference does not satisfy the threshold performance difference, select the machine learning model to perform intelligent gateway selection; or in response to determining that the difference satisfies the threshold performance difference, select the updated machine learning model to perform intelligent gateway selection. An example 13 that includes the subject matter of any of examples 8-12, and further includes the historical gateway data includes a plurality of records, each record including a transaction identifier, a gateway device identifier, payment data, and user profile data. An example 14 that includes the subject matter of any of examples 8-13, and wherein the user profile data includes previous transactions associated with the user profile data, and a risk metric of a failed transaction associated with the user profile data.

In an example 15, a system includes at least one memory device; and a processing device, operatively coupled with the at least one memory device, to receive a first request from a user system, wherein the first request includes user profile data including a transaction request and associated user data; identify a plurality of gateways that are available to process the request; measure a difference between a first performance metric of a machine learning model and a second performance metric of a updated machine learning model; and in response to determining that the difference satisfies a threshold performance difference, select the updated machine learning model to perform intelligent gateway selection for processing a subsequent transaction.

An example 16 that includes the subject matter of example 15, wherein the processing device is further caused to train the machine learning model using historical data of each gateway of the plurality of available gateways to predict a likely gateway that can successfully process the request. An example 17 that includes the subject matter of examples 15 or 16, wherein the historical gateway data includes a plurality of records, each record including a transaction identifier, a gateway device identifier, payment data, and user profile data. An example 18 that includes the subject matter of any of examples 15-17, wherein the user profile data includes previous transactions associated with the user profile data, and a risk metric of a failed transaction associated with the user profile data. An example 19 that includes the subject matter of any of examples 15-18, wherein the processing device is further caused to train the machine learning model, the training causing the processing device to sample historical gateway data for the plurality of available gateways using a sampling function optimized for at least two different optimization parameters; and train the updated machine learning model using updated historical gateway data that comprises sampled historical gateway data and additional historical gateway data. An example 20 that includes the subject matter of any of examples 15-19, wherein the processing device is further caused to further in response to determining that the difference does not satisfy the threshold performance difference, select the machine learning model to perform intelligent gateway selection for processing a subsequent transaction.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for selecting a gateway for processing payment transactions in response to a request from a user system, the method comprising:
receiving the request from the user system, wherein the request includes user profile data and transaction data including payment data;
identifying a plurality of gateways that are available to process the request;
selecting, by a machine learning model trained based on a set of sampled historical gateway data, the selected gateway from the plurality of available gateways;
communicating the request to the selected gateway; and
receiving, from the selected gateway, a response that indicates a success or failure of the request.

2. The method of claim 1, further comprising training the machine learning model using the set of sampled historical gateway data of each gateway of the available gateways to predict a likely gateway that can successfully process the request, wherein the training comprises sampling historical gateway data for the plurality of available gateways using a sampling function optimized for at least two different optimization parameters.

3. The method of claim 1 further comprising:
identifying a threshold number of failed transactions; and
in response to identifying the threshold number of failed transactions, generating an updated machine learning model by retraining the machine learning model using updated historical gateway data.

4. The method of claim 3 further comprising measuring a difference between a first performance metric of the machine learning model and a second performance metric of the updated machine learning model.

5. The method of claim 4 further comprising:
comparing the difference between the first performance metric and the second performance metric to a threshold performance difference;
in response to determining that the difference does not satisfy the threshold performance difference, selecting the machine learning model to perform intelligent gateway selection; or
in response to determining that the difference satisfies the threshold performance difference, selecting the updated machine learning model to perform intelligent gateway selection.

6. The method of claim 1, wherein the historical gateway data includes a plurality of records, each record including a transaction identifier, a gateway device identifier, payment data, and user profile data.

7. The method of claim 5, wherein the user profile data includes previous transactions associated with the user profile data, and a risk metric of a failed transaction associated with the user profile data.

8. A non-transitory computer-readable storage medium comprising instructions that, when executed by a processing device, cause the processing device to:
receive a request from a user system, wherein the request includes user profile data including a transaction request and associated user data;
identify a plurality of gateways that are available to process the request;
select, by a machine learning model trained based on a set of sampled historical gateway data, a selected gateway from the plurality of available gateways;
communicate the request to the selected gateway; and
receive, from the selected gateway, a response that indicates a success or failure of the request.

9. The non-transitory computer-readable storage medium of claim 8, wherein the processing device is further caused to: train the machine learning model using the historical gateway data of each gateway of the plurality of available gateways to predict a likely gateway that can successfully process the request, wherein to train the machine learning model comprises causing the processing device to sample historical gateway data for the plurality of available gateways using a sampling function optimized for at least two different optimization parameters.

10. The non-transitory computer-readable storage medium of claim 8, wherein the processing device is further caused to:
identify a threshold number of failed transactions; and
in response to identifying the threshold number of failed transactions, generate an updated machine learning model by retraining the machine learning model using updated historical gateway data.

11. The non-transitory computer-readable storage medium of claim 10, wherein the processing device is further caused to measure a difference between a first performance metric of the machine learning model and a second performance metric of the updated machine learning model.

12. The non-transitory computer-readable storage medium of claim 11, wherein the processing device is further caused to:
compare the difference between the first performance metric and the second performance metric to a threshold performance difference;
in response to determining that the difference does not satisfy the threshold performance difference, select the machine learning model to perform intelligent gateway selection; or
in response to determining that the difference satisfies the threshold performance difference, select the updated machine learning model to perform intelligent gateway selection.

13. The non-transitory computer-readable storage medium of claim 8, wherein the historical gateway data includes a plurality of records, each record including a transaction identifier, a gateway device identifier, payment data, and user profile data.

14. The non-transitory computer-readable storage medium of claim 8, wherein the user profile data includes previous transactions associated with the user profile data, and a risk metric of a failed transaction associated with the user profile data.

15. A system comprising:
at least one memory device; and
a processing device, operatively coupled with the at least one memory device, to:
receive a first request from a user system, wherein the first request includes user profile data including a transaction request and associated user data;
identify a plurality of gateways that are available to process the request;
measure a difference between a first performance metric of a machine learning model and a second performance metric of a updated machine learning model; and
in response to determining that the difference satisfies a threshold performance difference, select the updated machine learning model to perform intelligent gateway selection for processing a subsequent transaction.

16. The system of claim 15, wherein the processing device is further caused to train the machine learning model using historical data of each gateway of the plurality of available gateways to predict a likely gateway that can successfully process the request.

17. The system of claim 16, wherein the historical gateway data includes a plurality of records, each record including a transaction identifier, a gateway device identifier, payment data, and user profile data.

18. The system of claim 15, wherein the user profile data includes previous transactions associated with the user profile data, and a risk metric of a failed transaction associated with the user profile data.

19. The system of claim 15, wherein the processing device is further caused to:
train the machine learning model, the training causing the processing device to:
sample historical gateway data for the plurality of available gateways using a sampling function optimized for at least two different optimization parameters; and
train the updated machine learning model using updated historical gateway data that comprises sampled historical gateway data and additional historical gateway data.

20. The system of claim 15, wherein the processing device is further caused to:
further in response to determining that the difference does not satisfy the threshold performance difference, select the machine learning model to perform intelligent gateway selection for processing a subsequent transaction.
